(19) United States
(12) Patent Application Publication
(10) Pub. No.: US 2007/0211657 A1
(43) Pub. Date: Sep. 13, 2007

(54) Apparatus and Method for Assigning Time Domain Resources to a Receiver

(75) Inventors: Sean McBeath, Keller, TX (US); Hao Bi, Lake Zurich, IL (US); Danny Pinckley, Arlington, TX (US); John Reed, Arlington, TX (US); Jack Smith, Valley View, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,656

(22) Filed: Mar. 9, 2006

(51) Int. Cl. H04Q 7/00

(52) U.S. Cl. 370/329; 370/347

(57) ABSTRACT

In order to address the above-mentioned need, a method and apparatus for assigning time-domain resources to a wireless receiver is provided herein. During operation a resource assigned to a particular node will comprise a particular-length subframe having a unique combination of a number of contiguous slots and a slot start time. The subframe will repeat after a predetermined number of slots to form a subframe pattern. For a given frequency resource (group of subchannels), each node to which the base station is transmitting a packet will have a unique subframe length, starting slot, and repetition time period. Because each node will be assigned a subframe pattern having a particular length, and because each node's transmissions will begin at varying slots, the resources may be assigned to multiple nodes without having any transmissions overlap.

### FIELD OF THE INVENTION

The present invention relates generally to communication systems and, in particular, to a method and apparatus for assigning time-domain resources to a wireless receiver.

### BACKGROUND OF THE INVENTION

Presently, cellular systems are being developed which employ slot sizes of approximately 0.5 milliseconds. At the same time, for orthogonal frequency division multiple access (OFDMA) systems, the frequency domain is being divided into groups of subcarriers, called subchannels, where a subchannel has an approximate total bandwidth of 200-300 kHz. A subchannel may be a group of contiguous subcarriers or a group of non-contiguous subcarriers. A scheduler is typically used to allocate slots and subchannels to a wireless receiver (sometimes referred to as node or access terminal (AT)) for data transmission. With small slot sizes, it is likely that multiple contiguous slots (called subframes), using one or more subchannels (frequencies), will be used for data transmission to a single wireless receiver. This is necessary, since the encoded packet for medium to large packet sizes may require more time-frequency resources than are available in one subchannel and one time slot to allow a sufficient effective coding rate after the initial transmission.

Hybrid automatic repeat request (HARQ) is commonly used in communication systems. In a HARQ system, a source communication unit (sometimes referred to as a base station or an access network (AN)) transmits an initial transmission to a wireless receiver. The source communication unit then waits for an acknowledgment (ACK) or negative acknowledgment (NAK) indication from the wireless receiver. If the base station receives a NAK, then it repeats the transmission to the wireless receiver or sends additional parity information to the wireless receiver as the second transmission. This process is repeated for the defined number of transmissions or until the wireless receiver sends an acknowledgment.

Some cellular systems, such as the one defined by the current high rate packet data (HRPD) standard, employ synchronous hybrid automatic repeat request (S-HARQ). In a S-HARQ system, the base station transmits an initial transmission to a wireless receiver. Then, it waits for an acknowledgment (ACK) or negative acknowledgment (NAK) indication from the wireless receiver. If the base station receives a NAK, then it repeats the transmission to the wireless receiver or sends additional parity information to the wireless receiver, such that the time of the initial transmission and next transmission is known by the wireless receiver with a repeating pattern of slots. In this way, the base station does not need to send additional control information to set up each transmission(s) after the first transmission in the S-HARQ transmission.

A problem arises when a S-HARQ system defines multiple subframe sizes. For such a system, the S-HARQ structure must be established such that multiple wireless receivers can share the time-domain resources without potential overlap on the first and subsequent transmissions of the S-HARQ process. Therefore, a need exists for a method and apparatus for assigning time-domain resources to a set of wireless receivers in a S-HARQ system, such that the resources for each wireless receiver do not overlap.

### BRIEF DESCRIPTION OF THE DRAWINGS

FIG. 1 is a block diagram of a communication system.

FIG. 2 through FIG. 5 illustrate timing structures for the communication system of FIG. 1.

FIG. 6 is a block diagram of a wireless communication device.

FIG. 7 is a block diagram of the base station of FIG. 1

FIG. 8 is a flowchart showing operation of the base station of FIG. 7.

### DETAILED DESCRIPTION OF THE DRAWINGS

In order to address the above-mentioned need, a method and apparatus for assigning time-domain resources to a wireless receiver is provided herein. During operation a resource assigned to a particular node will comprise a particular-length subframe having a unique combination of a number of contiguous slots and a slot start time. The subframe will repeat after a predetermined number of slots to form a subframe pattern. For a given frequency resource (group of subchannels), each node to which the base station is transmitting a packet will have a unique subframe length, starting slot, and repetition time period. Because each node will be assigned a subframe pattern having a particular length, and because each node's transmissions will begin at varying slots, the resources may be assigned to multiple nodes without having any transmissions overlap.

The present invention encompasses a method for assigning time domain resources to wireless receivers in a wireless communication system. The method comprises the steps of determining a first subframe pattern for a first node. The first subframe pattern comprises a first subframe that repeats at specific intervals. A first starting slot is determined for the first node, and information is transmitted regarding the first subframe pattern to the first node. Finally data is transmitted to the first node using the first subframe pattern.

The present invention additionally encompasses an apparatus comprising logic circuitry determining a first subframe pattern for a first node, where the first subframe pattern comprises a first subframe that repeats at specific intervals, the logic circuitry additionally determines a first starting slot for the first subframe pattern. The apparatus comprises a transmitter transmitting information regarding the first subframe pattern to the first node, the transmitter additionally transmitting data to the first node using the first subframe pattern.

The present invention additionally encompasses a method for operating a wireless receiver. The method comprises the steps of receiving information regarding a subframe pattern. The subframe pattern comprises a subframe that repeats at specific intervals, and the subframe comprises a plurality of slots. A starting slot is determined and data is received from a node or base station using the subframe pattern beginning at the starting slot.

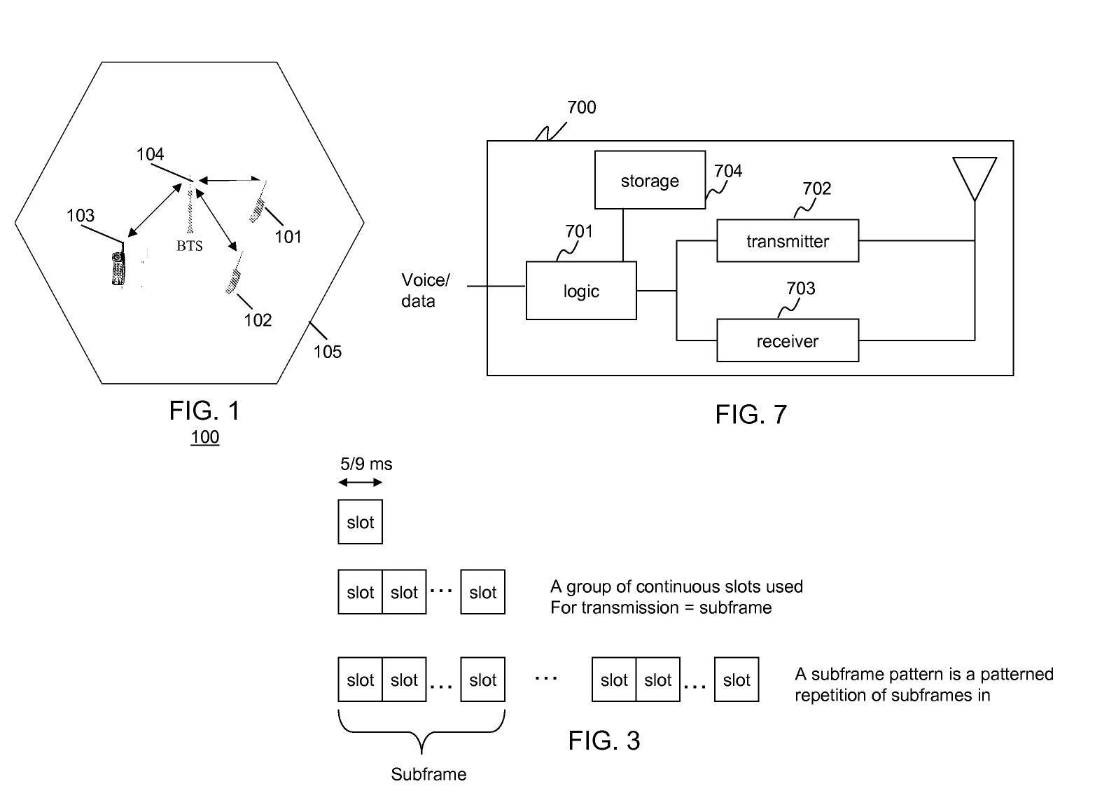

Turning now to the drawings, wherein like numerals designate like components, FIG. 1 is a block diagram of communication system 100. Communication system 100 comprises a plurality of cells 105 (only one shown) each having a base transceiver station (BTS, or base station) 104 in communication with a plurality of wireless nodes 101-103. Wireless nodes 101-103 may be wireless communication devices such as access terminals, wireless telephones, cellular telephones, personal digital assistants, pagers, personal computers, mobile communication devices, or any other device that is capable of sending and receiving communication signals on a wireless network. Communication system 100 utilizes a next generation Orthogonal Frequency Division Multiplexed (OFDM) or multicarrier based architecture using HARQ, S-HARQ or a combination of the two. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. In alternate embodiments communication system 100 may utilize other cellular communication system protocols such as, but not limited to, TDMA or direct sequence CDMA.

During operation, base station 104 can assign time-domain resources for wireless nodes 101-103 by sending the wireless nodes 101-103 an indication of the time-domain resources. These resources comprise particular frequencies (subchannels) and slots for communication between base station 104 and nodes 101-103. The indication of the time-domain resources may be sent out on a separate control channel.

Since any particular node 101-103 is not typically assigned the entire time domain resource, the base station 104 can assign multiple wireless nodes 101-103 to different portions of the same time domain resource. As discussed above, for an S-HARQ system, base station 104 must ensure that the first and subsequent transmissions for any resources assigned do not overlap. In order to accomplish this, the resource assigned to a particular node 101-103 will comprise a particular-length subframe having a unique combination of a number of contiguous slots and a slot start time. The subframe will repeat after a predetermined number of slots to form a subframe pattern.

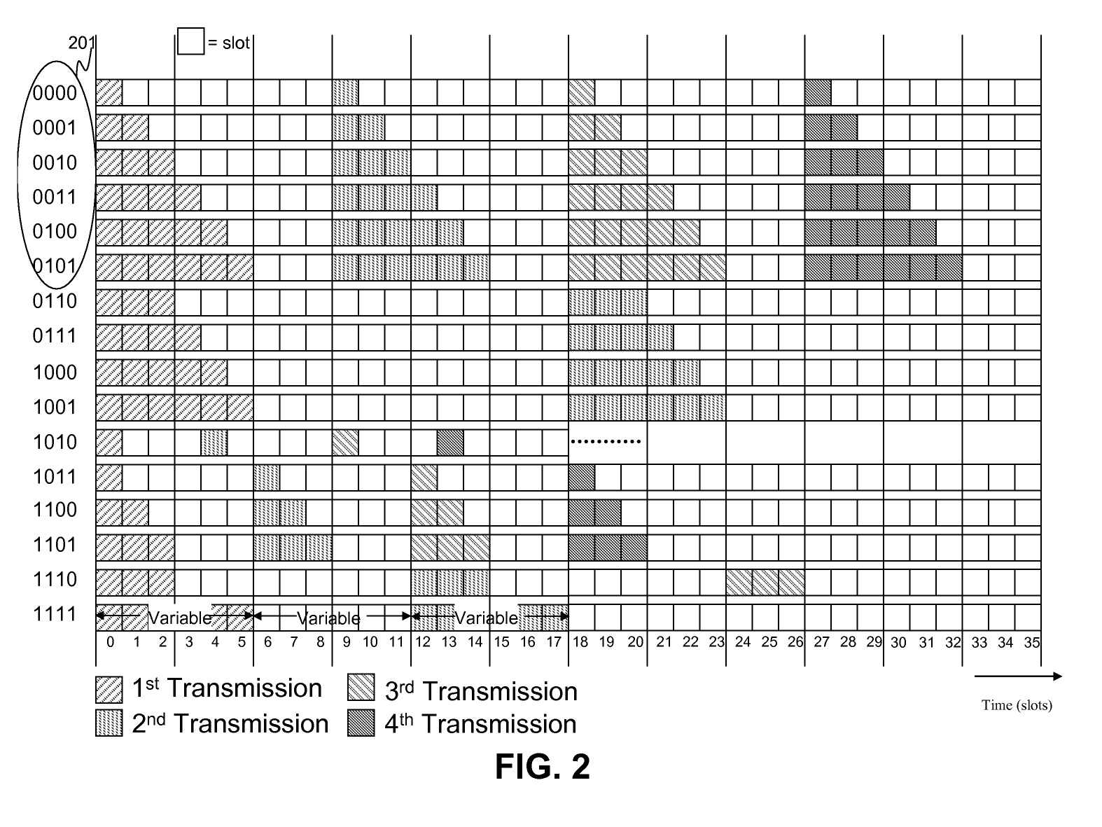

Because each node sharing the same frequency resource will be assigned a group of subframe patterns having a particular length, and because each node's transmissions will begin at varying slots, the resources may be assigned to multiple nodes 101-103 without having any transmissions overlap. This is illustrated in FIG. 2 through FIG. 6. It should be noted that the dynamics of scheduling users to subframe assignments may produce unused or unassigned slots, which is expected. Further, in some cases, e.g. such as light loading, not all the possible subframe assignments will be made. This may also be done in order to mitigate interference from other sectors or cells.

FIG. 2 shows subframe transmissions. In this illustrative example, a subframe may comprise any number of slots. Additionally, in this example 16 subframe patterns are established that repeat every 9/2, 6, 9, 12, or 18 slots. As is evident, each subframe pattern is assigned a four bit binary value. In this illustrative example, a time slot is defined to be ⅓ of the time slot used in another communications standard. For example, the communications standard HRPD Rev-B defines a slot to be 1⅔ msec. In this example, a slot is defined to be 5/9 msec. Since the slots for communication system 100 and the HRPD standard line up every 1⅔ msec, a wireless receiver can easily switch between the systems.

In subframe patterns ‘0000’ through ‘0101’, a subframe pattern that repeats every 9 slots is established. These six subframe patterns have subframe sizes ranging from 1 to 6 contiguous slots and are defined to be a group of subframe patterns 201. Further, in all six subframe patterns, the number of slots between the first slot of a subframe and the first slot of the next subframe is fixed at 9 slots. This is illustrated in FIG. 3.

As shown in FIG. 3, slot sizes are 5/9 milliseconds. With small slot sizes, communication system 100 utilizes a group of continuous slots, called subframes. These subframes can repeat in a known pattern, called a subframe pattern.

Returning to FIG. 2, consider subframe pattern ‘0010’. In this subframe pattern, each subframe is comprised of three contiguous slots (slots 0-2) that are used for the first transmission to a wireless receiver. Then, the wireless receiver decodes the transmission and reports an ACK/NAK indication to base station 104. Next, if the wireless receiver indicated a NAK, then base station 104 sends the next transmission in three contiguous slots (slot 9-11). This process is repeated until the wireless receiver reports an ACK or the maximum number of transmissions is reached. Since this is S-HARQ, base station 104 and the wireless receiver use a fixed relationship for transmitting and receiving initial and subsequent transmissions.

In subframe patterns ‘0110’ through ‘1001’, a subframe repeats every 18 slots. Note that this repetition length (i.e., the number of slots for a subframe to repeat) is twice that of subframe patterns ‘0000’ through ‘0101’, which repeat every 9 slots. In these four subframe patterns, subframe sizes are defined between 3 and 6 slots, and the number of slots between the first slot of a transmission and the first slot of the next transmission is fixed at 18 slots. These four subframe patterns are defined to be a group of subframe patterns.

Defining one group of subframe patterns to be have a repetition length that is an integer multiple of another group of subframe patterns is beneficial for sharing the entire set of time-domain resources among a plurality of wireless receivers. In this way, two wireless receivers having a repetition length of 18 slots uses the same time-domain resources as one wireless receiver having a repetition length of 9 slots, assuming the subframe sizes of the two wireless receivers are the same. Further, the group with a repetition length of 18 slots allows the wireless receiver more time to decode the packet.

In subframe pattern ‘1010’, a repetition length of 9/2 slots is established. Since transmission to a wireless receiver typically occupy an entire slot, the number of slots between the first transmission and second transmission is 4, the number of slots between the second transmission and third transmission is 5, the number of slots between the second transmission and third transmission is 4, while the number of slots between the third transmission and fourth transmission is 5. This process is repeated for all subsequent transmissions. This subframe pattern is advantageous for low delay services. This one subframe pattern is defined to be a group of subframe patterns.

In subframe patterns ‘1011’ through ‘1101’, a repetition length of 6 slots is established. In these three subframe patterns, subframe sizes are defined between 1 and 3 slots, and the number of slots between the first slot of a transmission and the first slot of the next transmission is fixed at 6 slots. These three subframe patterns are defined to be a group of subframe patterns.

In subframe patterns ‘1110’, a repetition length of 12 slots is established. In this subframe patterns, the subframe sizes is defined as 3 slots, and the number of slots between the first slot of a transmission and the first slot of the next transmission is fixed at 12 slots. This one subframe pattern is defined to be a group of subframe patterns.

Finally, in subframe pattern ‘1111’, the number of slots in the first and subsequent transmission is variable, while the number of slots between transmissions is variable. This subframe pattern is used to indicate to the wireless receiver that S-HARQ is not being used. This one subframe pattern is defined to be a group of subframe patterns.

In each of the 16 subframe patterns, the pattern can begin in any time slot that is available for data transmission. This allows the time domain resource to be completely shared. This example is intended to be illustrative only. Various other subframe patterns accomplish the same goal.

Base station 104 can transmit the time domain assignment to the wireless receiver on a control channel by indicating a subframe pattern identification and the beginning slot. The beginning slot can be the same slot in which the control channel is received, can be a slot with a fixed relationship relative to the control channel slot, or can be explicitly signaled. Base station 104 can use an index value, where the index represents the determined subframe pattern, to transmit the time domain assignment. Base station 104 can assign all wireless receivers sharing a same frequency resource (group of subchannels) to a same group of subframe patterns or multiple groups of subframe patterns, where the multiple groups have a repetition length that are integer multiples of each other. For example, base station 104 can assign all wireless receivers sharing subchannel 1 to the two subframe groups containing subframe patterns ‘0000’ through ‘1001’, while assigning all wireless receivers sharing subchannel 2 to the two subframe groups containing subframe patterns ‘1011’ through ‘1110’. This is desirable when different services are being offered in different frequency resources.

In response to each transmission, the wireless receiver may transmit an ACK/NAK response. The ACK/NAK information can be transmitted from the wireless receivers using one of a plurality of available modulation schemes. For example, the ACK/NAK information can be transmitted using binary phase shift keying (BPSK). Alternatively, the ACK/NAK information can be transmitting using on-off keying. Note that different wireless receivers could use different modulation schemes for transmitting their ACK/NAK information. Alternatively, different service types could rely on different modulation schemes. The timing of the ACK/NAK response can have a fixed relationship to the first slot of the subframe, a fixed relationship to the last slot of the subframe, or the like. Further, the timing of the ACK/NAK response can depend on the assigned subframe pattern. For example, the ACK/NAK information could be transmitted seven slots after the first slot of the subframe for subframe patterns ‘0000’ through ‘0101’ and could be transmitted five slots after the first slot of the subframe for subframe patterns ‘1011’ though ‘1101’. The ACK/NAK timing can be indicated to the wireless receiver by base station 104 on a control channel or can be stored at the wireless receiver.

Certain wireless receivers may not be able to decode a packet and respond with an ACK/NAK indication in the required time frame for some combinations of group and subframe. Therefore, base station 104 may only assign subframe patterns to certain wireless receivers such that the wireless receiver has sufficient processing time to decode the packet and respond with an ACK/NAK indication. The capability of the wireless receiver can be transmitted from the wireless receiver to base station 104 or can be determined at base station 104.

FIG. 4 illustrates subframe transmission. Like the previous example, 16 subframe patterns are defined, each of which can be indexed by a four bit binary value. In this illustrative example, a time slot is defined to be ½ of the time slot utilized in another communications standard. Thus a slot is defined such that a total duration of an integer number of consecutive slots is equivalent to a slot length in another communication system. For example, the communications standard HRPD Rev-B defines a slot to be 1⅔ msec. In this example, a slot is defined to be ⅚ msec. Since the slots in this example and the HRPD standard line up every 1⅔ msec, a wireless receiver can easily switch between the systems. The repetition length for the three basic groups of subframe patterns is 3, 6, and 12 time slots.

FIG. 5 illustrates subframe transmission. Like the previous example, 16 subframe patterns are defined, each of which can be indexed by a four bit binary value. In this illustrative example, a time slot is defined to be ½ of the time slot utilized in another communications standard. For example, the communications standard HRPD Rev-B defines a slot to be 1⅔ msec. In this example, a slot is defined to be ⅚ msec. Since the slots in this example and the HRPD standard line up every 1⅔ msec, a wireless receiver can easily switch between the systems. The repetition length for the three basic groups of subframe patterns is 4, 8, and 16 time slots.

The entire set of defined subframe patterns may be used at any one time by the base station, or a subset of subframe patterns may be used. For example, the network may create a subset of subframe patterns to limit the amount of control channel overhead. This subset is indicated on a control channel message and may be common to all users in the system. For example, referring again to FIG. 2, the network may create a subset of subframe patterns containing subframe patterns ‘1011’-‘1110’. Since the subset contains only 4 subframe patterns, the base station only needs to transmit two bits to indicate the subframe pattern among the subset rather than the four bits required to index the entire set

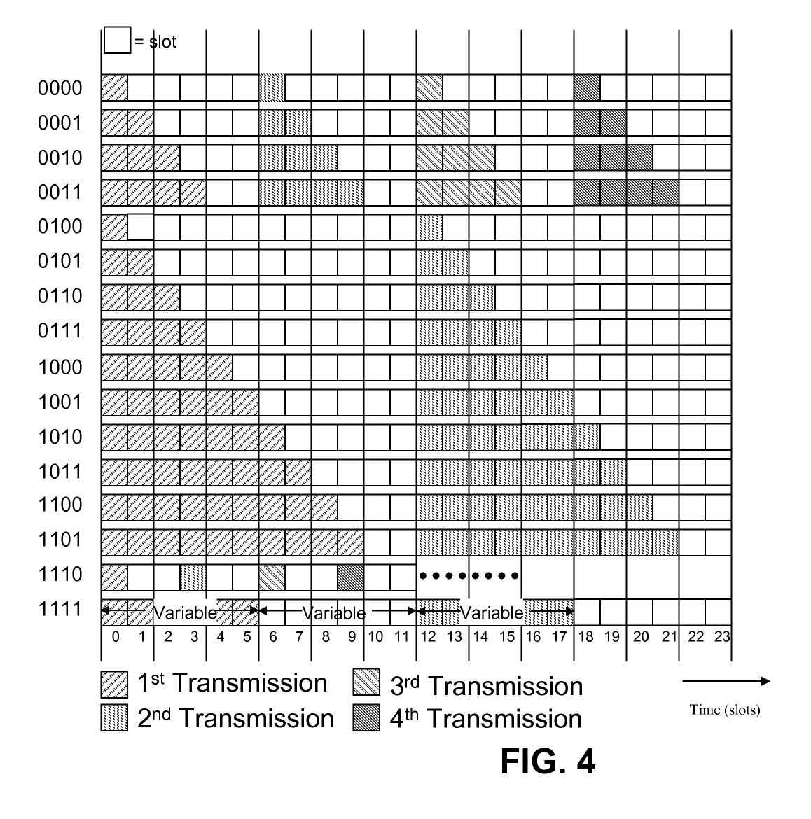

FIG. 6 illustrates subframe transmission to multiple receivers. This example illustrates how the subframe patterns are used to share the time-domain resources among a plurality of wireless receivers. This example uses the subframe patterns defined in FIG. 2. Wireless receiver 1 is assigned subframe pattern ‘0010’ beginning time slot 1. The first transmission occupies three contiguous time slots, beginning in time slot 1. The second transmission, if necessary, occupies three contiguous time slots beginning in time slot 10. Additional transmissions, if necessary, follow the same pattern. Wireless receiver 2 is assigned subframe pattern ‘0011’ beginning in time slot 5. The first transmission occupies four contiguous slots, beginning in time slot 5. The second transmission, if necessary, occupies four contiguous time slots beginning in time slot 14. Additional transmissions, if necessary, follow the same pattern. Wireless receiver 3 is assigned subframe pattern ‘1010’, beginning in time slot 0. The first transmission is in time slot 0, and the second through fourth transmissions, if required, are be in time slots 4, 9, and 13 respectively. Additional transmissions, if necessary, follow the same pattern. If one of the three wireless receivers sends an ACK, then a new packet can be transmitted to the wireless receiver using some or all of the available time slots. Alternatively, one or more wireless receivers can be assigned some or all of the available time slots. As is evident, all three nodes can utilize a same frequency resource without any chance of overlapping transmissions.

Note that multiple wireless receivers may share the same timing pattern and the same subchannel (the same time-frequency resource), if another multiplexing scheme is established. For example, multiple user packets can be used to share the same time-frequency resources among a plurality of wireless receivers. Using multiple user packets, the base station transmits data simultaneously to multiple wireless receivers by concatenating the data intended for the multiple wireless receivers prior to encoding. Each wireless receiver then decodes the multiple user packet and determines the portion of the packet intended for it. Alternatively, CDMA (code division multiple access) could be used to share the same time-frequency resource, where each wireless receiver is assigned a different Walsh code. Alternatively, SDMA (spatial division multiple access) could be used to share the same time frequency resource among a plurality of wireless receivers, where each wireless receiver is served using different antenna weights resulting in different spatial signatures.

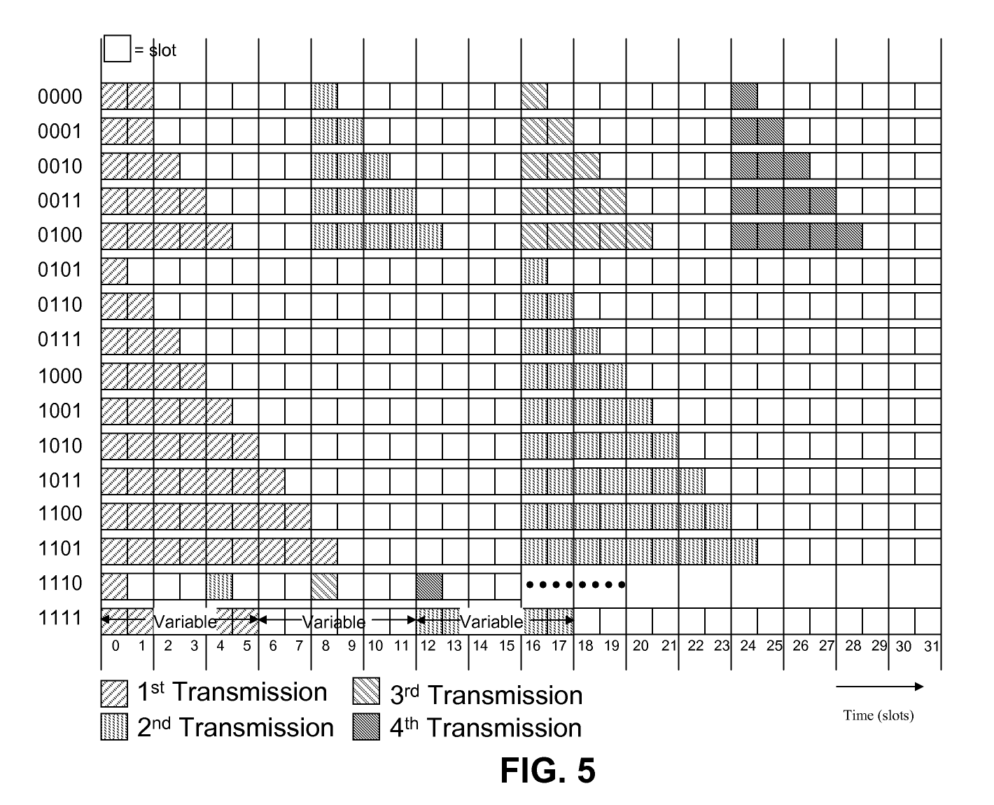

FIG. 7 is a block diagram of a node within communication system 100. Node 700 may serve as base station 104, or may serve as nodes 101-103. Regardless of whether node 700 serves as base station 104 or node 101-103, node 700 comprises logic circuitry 701, transmit circuitry 702, and receive circuitry 703. Logic circuitry 701 preferably comprises a microprocessor controller, such as, but not limited to a Freescale PowerPC microprocessor. In the preferred embodiment of the present invention logic circuitry 701 serves as means for controlling base station 104, and as means for assigning mobile nodes 101-103 a particular subframe pattern and starting slot. Transmit and receive circuitry 702-703 are common circuitry known in the art for communication utilizing well known network protocols, and serve as means for transmitting and receiving voice/data/messages. For example, transmitter 702 and receiver 703 are well known OFDM transmitters and receivers that utilize, for example, the IEEE 802.16 communication system protocol. Other possible transmitters and receivers include, but are not limited to transceivers utilizing Bluetooth, IEEE 802.16, E-UTRA, the evolution of HRPD, or HyperLAN protocols. Finally, storage 704 comprises standard random access memory and is utilized for storing subframe patterns and their associated index.

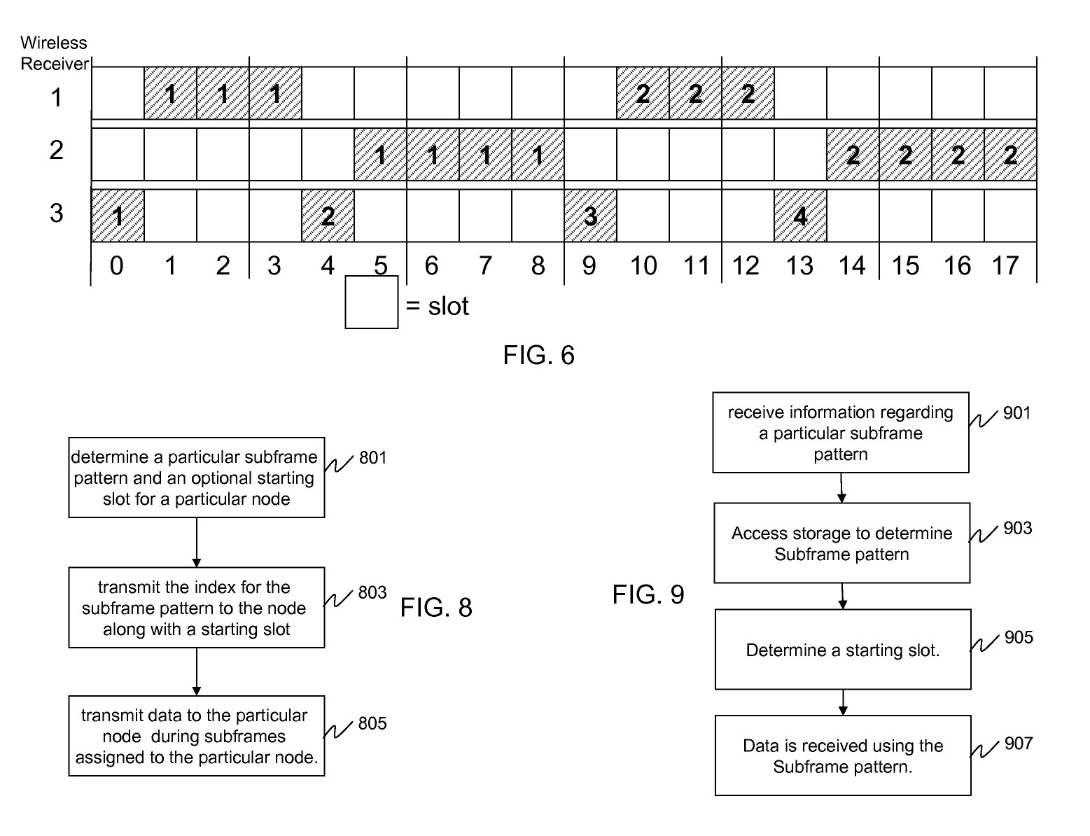

FIG. 8 is flowchart illustrating the operation of base station 104. The logic flow begins at step 801 where logic circuitry 701 accesses storage 704 and determines a first subframe pattern for a first node and a first starting slot for first node. As discussed above, the first subframe pattern and first starting slot will be chosen to avoid interfering with other nodes. At step 803, logic circuitry transmits information regarding the first subframe pattern (e.g., an index for the subframe pattern) to the first node and optionally transmits information regarding the first starting slot to the first node. The information regarding the first starting slot may simply comprise a control channel transmission. The starting slot can be the same slot in which the control channel is received, can be a slot with a fixed relationship relative to the control channel slot, or can be explicitly signaled. The logic flow continues to step 805 where data is transmitted (via transmitter 702) to the first node using the first subframe pattern (e.g., during subframes assigned to the particular node). As discussed above, any NAK received by receiver 703 will cause logic circuitry 701 to instruct transmitter 702 to retransmit data to the particular node during subsequent subframes until the maximum number of transmission is reached.

It should be noted that the above logic flow comprises those steps necessary to transmit to a single node. One of ordinary skill in the art will recognize that when a base station wishes to transmit to a second node, the above steps will be repeated for the second node. Particularly, logic circuitry 701 will determine a second subframe pattern for a second node, wherein the second subframe pattern comprises a second subframe that repeats at specific intervals. A second starting slot will also be determined for the second node. Transmitter 702 will transmit information regarding the second subframe pattern and information regarding the second starting slot to the second node. The second starting slot may have a fixed relationship to a second control channel slot, differing from the first control channel slot. Finally, transmitter 702 will transmit data to the second node using the second subframe pattern.

As discussed above, the first subframe will comprise a first number of slots and the second subframe will comprise a second number of slots, which may differ from the first number of slots. The first subframe pattern may have a repetition length that is an integer multiple of the second subframe pattern. Additionally, the first starting slot may differ in time from the second starting slot, and the first subframe may repeat after a first number of slots, with the second subframe repeating after a second number of slots.

Each subframe pattern may be taken from a group having the same number of slots between the fist slot of a subframe and a first slot of the next subframe. This may result in the first subframe pattern being taken from a first group of subframe patterns that have the same number of slots between a first slot of a subframe and a first slot of a next subframe and the second subframe pattern being taken from a second group of subframe patterns that have the same number of slots between a first slot of a subframe and a first slot of a next subframe.

When serving as node 101-103, node 700 will receive data (via receiver 703) utilizing the subframe pattern as described above. The subframe pattern is taken from a group of differing subframe patterns. FIG. 9 is a flow chart showing operation of node 700 when receiving data. The logic flow begins at step 901 where receiver 703 receives information (e.g., an index) regarding a particular subframe pattern. At step 903 logic circuitry 701 accesses storage 704 to match the index to a certain subframe pattern. As discussed above, the subframe pattern comprises a subframe that repeats at specific intervals, and wherein the subframe comprises a plurality of slots. At step 905 a starting slot is determined. As discussed above, the starting slot may be conveyed to receiver 703 via standard messaging, or may be related to the control channel transmission. Once the subframe pattern and the starting slot are known, the logic flow continues to step 907 where data is received from a node or a base station using the subframe pattern beginning at the first starting slot.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for assigning time domain resources to wireless receivers in a wireless communication system, the method comprising the steps of:
determining a first subframe pattern for a first node, wherein the first subframe pattern comprises a first subframe that repeats at specific intervals;
determining a first starting slot for the first node;
transmitting information regarding the first subframe pattern to the first node; and
transmitting data to the first node using the first subframe pattern.

2. The method of claim 1 further comprising the steps of:
determining a second subframe pattern for a second node, wherein the second subframe pattern comprises a second subframe that repeats at specific intervals;
determining a second starting slot for the second node;
transmitting information regarding the second subframe pattern to the second node; and
transmitting data to the second node using the second subframe pattern.

3. The method of claim 2 wherein the first subframe comprises a first number of slots.

4. The method of claim 3 wherein the second subframe comprises a second number of slots differing from the first number of slots.

5. The method of claim 2 wherein the first starting slot differs in time from the second starting slot.

6. The method of claim 2 wherein the first subframe repeats after a first number of slots and the second subframe repeats after a second number of slots.

7. The method of claim 2 wherein the first subframe pattern is taken from a first group of subframe patterns that have a same number of slots between a first slot of a subframe and a first slot of a next subframe.

8. The method of claim 9 wherein the second subframe pattern is taken from a second group of subframe patterns that have a same number of slots between a first slot of a subframe and a first slot of a next subframe.

9. The method of claim 2 wherein the first subframe pattern has a repetition length that is an integer multiple of the second subframe pattern.

10. The method of claim 2 wherein the step of transmitting information regarding the first subframe pattern comprises the step of transmitting an index to the first subframe pattern.

11. The method of claim 2 wherein the first starting slot has a fixed relationship to a control channel slot and the second starting slot has a fixed relationship to a second control channel slot.

12. The method of claim 1 further comprising the step of:
transmitting information regarding the first starting slot to the first node.

13. The method of claim 1 wherein a slot is defined such that a total duration of an integer number of consecutive slots is equivalent to a slot length in another communication system.

14. The method of claim 1 further comprising the steps of:
receiving a negative acknowledgment (NAK) from the first node; and
in response to the NAK, transmitting information to the first node in a next subframe.

15. An apparatus comprising:
logic circuitry determining a first subframe pattern for a first node, wherein the first subframe pattern comprises a first subframe that repeats at specific intervals, the logic circuitry additionally determining a first starting slot for the first subframe pattern; and
a transmitter transmitting information regarding the first subframe pattern to the first node, the transmitter additionally transmitting data to the first node using the first subframe pattern.

16. The apparatus of claim 15 wherein:
the logic circuitry additionally determines a second subframe pattern for a second node, wherein the second subframe pattern comprises a second subframe that repeats at specific intervals and determines a second starting slot for the second subframe pattern; and
the transmitter additionally transmits information regarding the second subframe pattern to the second node.

17. The apparatus of claim 16 wherein the first subframe comprises a first number of slots.

18. The apparatus of claim 16 wherein the second subframe comprises a second number of slots differing from the first number of slots.

19. A method for operating a wireless receiver, the method comprising the steps of:
receiving information regarding a subframe pattern, wherein the subframe pattern comprises a subframe that repeats at specific intervals, and wherein the subframe comprises a plurality of slots;
determining a starting slot; and
receiving data from a node or base station using the subframe pattern beginning at the starting slot.

20. The method of claim 19 wherein the subframe pattern is taken from a group of differing subframe patterns.
